(19) United States
(12) Patent Application Publication
(10) Pub. No.: US 2011/0093788 A1
(43) Pub. Date: Apr. 21, 2011

(54) SYSTEM AND METHOD FOR PERSONALIZING CONTENT FOR A MOBILE DEVICE

(75) Inventors: Serge RUTMAN, Boulder Creek, CA (US); Vincent LE CHEVALIER, San Jose, CA (US)

(73) Assignee: FIRSTPAPER LLC, NEW YORK, NY (US)

(21) Appl. No.: 12/579,797

(22) Filed: Oct. 15, 2009

(51) Int. Cl. G06F 15/16; G06F 3/01

(52) U.S. Cl. 715/745; 709/217

(57) ABSTRACT

A system and method for personalizing content for a mobile device is provided. The system for personalizing content for a mobile device may comprise an acquisition module that may capture user identifiable content associated with the current user of the mobile device. The acquisition module may be coupled to the mobile device. The system may also comprise a storage module that may store personalized content associated with one or more users of the mobile device. The system may additionally comprise a selection module that may receive the user identifiable content. The selection module may also compare the user identifiable content to the personalized content. The selection module may further determine the current user of the mobile device based on the user identifiable content. The selection module may additionally retrieve the personalized content directly associated with the current user of the mobile device.

### FIELD OF THE INVENTION

The present invention generally relates to a system and method for personalizing content for a mobile device.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram of a system for personalizing content for a mobile device according to an embodiment of the present invention;

FIG. 2 is a schematic diagram of a system for personalizing content for a mobile device according to an embodiment of the present invention;

FIG. 3 is a flowchart of a method for personalizing content for a mobile device according to an embodiment of the present invention;

FIG. 4 is a flowchart of a method for personalizing content for a mobile device according to an embodiment of the present invention; and

FIG. 5 is a flowchart of a method for personalizing content for a mobile device according to an embodiment of the present invention.

### DETAILED DESCRIPTION OF EMBODIMENTS

Certain embodiments of the present invention provide a system and method for personalizing content for a mobile device. Embodiments of a system and method for personalizing content for a mobile device may be used to personalize content on the mobile device. The content of the mobile device may be tailored to the current user of the mobile device The content presented on the mobile device may change based on the current user of the mobile device. Embodiments of a system and method for personalizing content for a mobile device may also provide targeted materials to the current user of the mobile device based on the users' requests or personal preferences. For example, the current mobile device user may receive targeted advertisements for products based on the users' personal preferences. The personalization of the content on the mobile device may improve the overall user interaction with the mobile device. Embodiments of a system and method for personalizing content for a mobile device may also enhance the security features and the power consumption of the mobile device.

Traditional mobile devices present many engineering issues. One engineering issue arises due to the presentation of content on the mobile device. Traditional mobile devices generally include the same content on the mobile device regardless of the user of the device. Maintaining the same content on the mobile device regardless of the user may result in a user of the mobile device accessing documents or information that they should not be able to access. Also, maintaining the same content on the mobile device regardless of the user may result in a lackluster user experience. Another engineering issue arises due to the lack of security of traditional mobile devices. Traditional mobile devices generally have no awareness of the individual using the device. Traditional mobile devices generally fail to include a security scheme to prevent unauthorized individuals from using the mobile device. Some traditional mobile devices may use a login scheme, such as a user name and/or password, to identify the user of the mobile device. However, if the user name and/or password is determined by an unauthorized individual there is no mechanism to maintain the security of the mobile device.

Another engineering issue arises due to the power management of traditional mobile devices. Traditional mobile devices manage power based on the lack of frequent physical interaction with the device, such as a failure to press a key on a keypad. The power management system on traditional mobile devices believes that lack of frequent physical interaction means that the device is not being used. For example, traditional mobile devices typically enter a standby or reduced power mode because a user of the device fails to press a key or button on the mobile device.

These and other engineering challenges create a need for a system and method for personalizing content for a mobile device. There is a need to improve content presentation, power management and security of mobile devices.

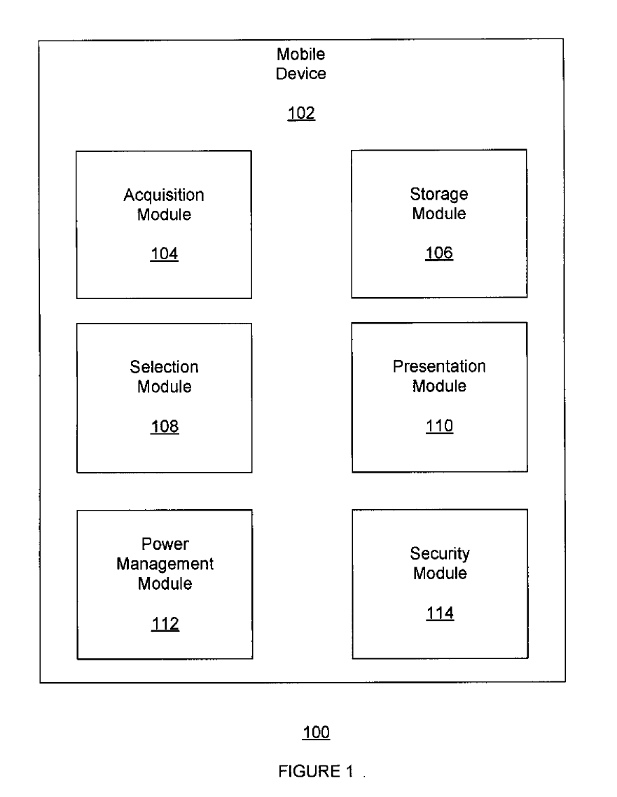

FIG. 1 is a schematic diagram of a system 100 for personalizing content for a mobile device 102 according to an embodiment of the present invention. The mobile device 102 may include an acquisition module 104, a storage module 106, a selection module 108, a presentation module 110, a power management module 112, and a security module 114. The mobile device 102 may be an electronic reader device, a mobile phone, a personal digital assistant, personal computing device, a tablet device or any other device that may be mobile.

The acquisition module 104 may be coupled to the mobile device 102. The acquisition module 104 may be any device capable of capturing content. The acquisition module 104 may be an image acquisition device, a camera, a video recording device, an audio recording device, a voice recognition device, a visual recognition device, or similar device. The acquisition module 104 may be internal or external to the mobile device 102. In some embodiments, the acquisition module 104 may be a camera that is internal to an electronic reader device. The acquisition module 104 may be operated by using computer-implemented software algorithms. The acquisition module 104 may be adaptive and use one or more algorithms to adapt to different situations.

The acquisition module 104 may be used to capture user identifiable content. The user identifiable content may be associated with a current user of the mobile device 102. The user identifiable content may be used to recognize or identify the current user of the mobile device 102. The user identifiable content may be one or more images, one or more audio recordings, one or more video recordings and/or any other content.

The acquisition module 104 may capture the user identifiable content automatically. The acquisition module 104 may capture the user identifiable content when a user interacts with the mobile device 102. In some embodiments, the acquisition device 104 may know when the mobile device 102 is being used by a user and capture user identifiable content at that time. For example, the acquisition module 104 may take a picture of the user of the mobile device 102 immediately when the device 102 is touched by the user. In some embodiments, the acquisition module 104 may capture the user identifiable content when a user presses a button or provides a command to the mobile device 102.

The acquisition module 104 may capture the user identifiable content at a periodic interval. In some embodiments, the acquisition module 104 may capture the user identifiable content at periodic intervals of 5 to 10 seconds. The acquisition module 104 may capture the user identifiable content at periodic intervals to determine the current user of the mobile device 102. For example, the acquisition module 104 may attempt to capture an image of the user of the mobile device 102 at 5 second intervals. The periodicity of the intervals may be based on one or more scenarios. For example, the periodicity of the intervals may be low when the mobile device 102 is in use (i.e. user pressing keys). When the device 102 hits a first period of inactivity, the periodicity of the intervals may be high. For example, when the mobile device 102 has not been touched by a user for 30 seconds, the acquisition module 104 may increase the periodicity of the intervals to capture an image every 10 seconds from a normal interval of capturing an image every 5 seconds during a period of device 102 activity. The periodicity of the intervals may be lowered to a point where a screen saver is displayed or the device 102 goes to sleep.

The capturing of the user identifiable content may be driven by algorithms based on end user interaction with the mobile device 102. In some embodiments, the acquisition module 104 may include a feedback mechanism. The feedback mechanism may be used to run a feedback loop to capture the user identifiable content to determine the current user of the mobile device 102. The feedback loop may be run automatically and/or periodically. In some embodiments, when the acquisition module 104 attempts to capture the user identifiable content, the acquisition module 104 may try to determine whether a user of the mobile device 102 is present. If the user of the mobile device 102 is not present, the acquisition device 104 may communication this information to the power management module 112.

The acquisition module 104 may be in communication with the storage module 106, the selection module 108, the presentation module 110, the power management module 112, and the security module 114. In some embodiments, the acquisition module 104 may communicate the user identifiable content to the storage module 106, selection module 108, power management module 112 and/or the security module 114.

The storage module 106 may be used to store content and data. The storage module 106 may be memory, a database or any other mechanism that can be used to store data. The storage module 106 may be used to store personalized content. The personalized content may be associated with one or more users of the mobile device 102. The personalized content may include the user identifiable content of one or more users of the mobile device 102. The personalized content of the one or more users of the mobile device 102 may be personal information, electronic books, periodicals, magazines, newspapers, software applications, personal preferences, personal documents and any other information. The personal information may be images, photographs, audio recordings, video recordings, names, addresses, usernames, passwords, and any other information that may be related to an individual. The storage module 106 may be coupled to the mobile device 102 or may be remote or external from the mobile device 102.

The storage module 106 may have multiple volumes of data associated with the personalized content of one or more users of the mobile device 102. The volumes of data may be segmented based on the user of the mobile device 102. In some embodiments, the storage module 106 may have all data associated with one user of the mobile device 102 separate from the data of another user of the mobile device 102. For example, personal information (e.g., name, address, picture, etc.), periodicals, newspapers, magazines, and electronic books of one user of the mobile device 102 may be maintained separately from data of other users of the mobile device 102.

The storage module 106 may build a personalized content file for a new user of the mobile device 102. The storage module 106 may receive from the acquisition module 104 user identifiable data associated with a user of the mobile device 102. The storage module 106 may create a personalized content file for the new user of the mobile device 102. The storage module 106 may store the personalized content for the new user of the mobile device 102.

The storage module 106 may store the personalized content so that it may be easily retrieved. The storage module 106 may be in communication with the acquisition module 104, the selection module 108, the presentation module 110, the power management module 112, and the security module 114. The storage module 106 may receive from the acquisition module 104 the user identifiable content. The storage module 106 may transmit the user identifiable content and/or the personalized content to the selection module 108, the presentation module 110, the power management module 112, and/or the security module 114. The selection module 108, the presentation module 110, the power management module 112 and/or the security module 114 may retrieve the user identifiable content and/or the personalized content from the storage module 106.

The selection module 108 may be capable of processing data. The selection module 108 may be a hardware or computer-implemented software component. The selection module 108 may be coupled to the mobile device 102 or may be remote or external from the mobile device 102. The selection module 108 may receive the user identifiable content. The selection module 108 may compare the user identifiable content to the personalized content. The selection module 108 may use computer-implemented software or computing algorithms to compare the user identifiable content to the personalized content. The software or computing algorithms may be audio, video or visual recognition algorithms. In some embodiments, the user identifiable content may be one or more pictures of the current user of the mobile device 102 and the personalized content may include one or more pictures of the one or more users of the mobile device 102. In this embodiment, the selection module 108 may compare the one or more pictures of the current user to the one or more pictures of all of the users of the mobile device 102.

The selection module 108 may analyze the personalized content against the user identifiable content to identify a digital match. The selection module 108 may perform this analysis using one or more computing algorithms. In some embodiments, the selection module 108 may analyze an audio recording of the current mobile device user against audio recordings of one or more users. The audio recordings may be analyzed, segmented and dissected by the selection module 108 to determine the current user of the mobile device 102.

The selection module 108 may determine the current user of the mobile device 102 based on the user identifiable content. The selection module 108 may use computer-implemented software or computing algorithms to determine the current user of the mobile device 102. The selection module 108 may identify the current user of the mobile device 102. In some embodiments, based on the results of the comparison between the user identifiable content and the personalized content, the selection module 108 may be able to determine the current user of the mobile device 102. The selection module 108 may retrieve the personalized content directly associated with the current user of the mobile device 102. The selection module 108 may retrieve the personalized content from the storage module 106. In some embodiments, the selection module 108 may request that the storage module 106 provide the personalized content for the current user of the mobile device 102. The selection module 108 may trigger user interface specific events when the current user of the mobile device 102 is determined. For example, the mobile device 102 may present the personalized content, personalized messages, account management features, and information specific to the current user of the mobile device 102.

The selection module 108 may be in communication with the acquisition module 104, the storage module 106, the presentation module 110, the power management module 112 and the security module 114. The selection module 108 may receive the user identifiable content associated with the current user of the mobile device 102 from the acquisition module 104 and/or the storage module 106. The selection module 108 may receive personalized content associated with one or more users of the mobile device 102 from the storage module 106. The selection module 108 may also receive personalized content directly associated with the current user of the mobile device 102 from the storage module 106.

The selection module 108 may communicate the personalized content associated with the current user of the mobile device 102 to the presentation module 110, the power management module 112, and/or the security module 114. The selection module 108 may communicate the results of the comparison of the user identifiable content to the personalized content to the storage module 106, the presentation module 110, the power management module 112 and the security module 114. The selection module 108 may communicate the identity of the current user of the mobile device 102 to the storage module 106, the presentation module 110, the power management module 112, and the security module 114. In some embodiments, the selection module 108 may perform the features of the power management module 112, the presentation module 110 and/or the security module 114.

The presentation module 110 may be used to present the personalized content on the mobile device 102. The presentation module 110 may display all personalized content associated with the current user of the mobile device 102. The presentation module 110 may upload the personalized content on the mobile device 102. The presentation module 110 may upload the personalized content so that the content may be displayed on the mobile device 102. In some embodiments, the presentation module 110 may upload one or more periodicals, magazines, newspapers, and electronic books, in additional to other personalized content, stored in the personalized content file of the current user of mobile device 102. The presentation module 110 may present the one or more magazines, in addition to other personalized content, so that they may be displayed on the mobile device 102 and accessible to the current user of the mobile device 102.

The presentation module 110 may be a display. In some embodiments, the display may be an electronic paper display (referred to as “EPD”), such as electrophoretic displays or electro-wetting displays. Examples of such displays include those disclosed in U.S. Pat. Nos. 6,577,433, 6,529,313, 6,525,866, 6,574,034, 6,017,584, 6,067,185, 6,118,426, 6,120,839, 6,124,851, 6,130,774, 6,172,798, 6,177,921, 6,232,950 and 6,249,271.

The presentation module 110 may be in communication with the acquisition module 104, the storage module 106, the selection module 108, the power management module 112 and the security module 114. The presentation module 110 may receive and/or retrieve the personalized content from the storage module 106. The presentation module 110 may upload the personalized content from the storage module 106. The presentation module 110 may receive the personalized content from the selection module 108, the power management module 112 and/or the security module 114.

The power management module 112 may adjust the power settings of the mobile device 102. The power management module 112 may adjust the power settings based on user identifiable content. The power management module 112 may be used to conserve the power of the mobile device 102. The power management module 112 may be implemented by using hardware and/or computer-implemented software. The power management module 112 may be implemented on, by way of non-limiting example, an ASIC, a field programmable gate array (“FPGA”), a complex programmable logic device (“CPLD”) or a dedicated integrated circuit. The power management module 112 may be a power controller.

The power management module 112 may use the user identifiable content to adjust the power settings of the mobile device 102. In some embodiments, the power management module 112 may use the user identifiable content to determine whether a user of the mobile device 102 is present. If the user of the mobile device 102 is present, the power management module 112 may keep the mobile device 102 in the on power mode. If the user of the mobile device 102 is not present, the power management module 112 may turn the mobile device 102 off or place the device 102 in a low power mode. The power management module 112 may automatically and/or periodically determine whether to adjust the power settings of the mobile device 102 based on the user identifiable content. In some embodiments, the power management module 112 may receive a communication from the acquisition module 102 informing the power management module 112 that the user of the mobile device 102 is not present. Upon receiving this information, the power management module 112 may turn the mobile device 102 off or place the mobile device 102 in a low power mode. The power management module 112 may be adaptive and use one or more algorithms to adapt to different situations.

The power management module 112 may be in communication with the acquisition module 104, the storage module 106, the selection module 108, the presentation module 110 and the security module 114. The power management module 112 may receive the user identifiable content or information regarding the user identifiable content from the acquisition module 104. The power management module 112 may receive personalized content from the storage module 106. The power management module 112 may communicate the power settings or power state of the mobile device 102 to the acquisition module 104, the storage module 106, the selection module 108, the presentation module 110, and the security module 114.

The security module 114 may be used to manage the security of the mobile device 102. The security module 114 may be coupled to the mobile device 102 or may be remote or external from the mobile device 102. The security module 114 may determine whether the current user of the mobile device 102 is an authorized user. The security module 114 may compare the user identifiable content to the personalized content to determine whether the current user of the mobile device 102 is an authorized user. The security module 114 may determine whether a user is authorized or unauthorized based on whether personalized content exists for the current user of the mobile device 102. For example, if no personalized content is available for the current user of the mobile device 102, the current user may be an unauthorized user or a first time user of the mobile device 102. The security module 114 may determine whether the user is authorized or unauthorized by checking information related to the current user of the mobile device 102 against a list maintained by the security module 114 and/or the storage module 106. The selection module 108 may also inform the security module 114 who is currently using the mobile device 102. The security module 114 may use this information to determine whether the current user of the mobile device 102 is authorized or unauthorized.

The security module 114 may provide the current user of the mobile device 102 access to the mobile device 102. The security module 114 may provide the current user of the mobile device 102 access if the current user is an authorized user. In some embodiments, the security module 114 may log the current user of the mobile device 102 onto the mobile device 102. The security module 114 may inform the presentation module 110 to present the personalized content associated with the current user on the mobile device 102.

The security module 114 may be in communication with the acquisition module 104, the storage module 106, the selection module 108, the presentation module 110 and the power management module 112. The security module 114 may receive the user identifiable content or information regarding the user identifiable content from the acquisition module 104 and/or the selection module 108. The security module 114 may receive personalized content from the storage module 106 and/or the selection module 108. The security module 114 may communicate with the selection module 108, the storage module 106 and the presentation module 110 whether the current user of the mobile device 102 is an authorized user.

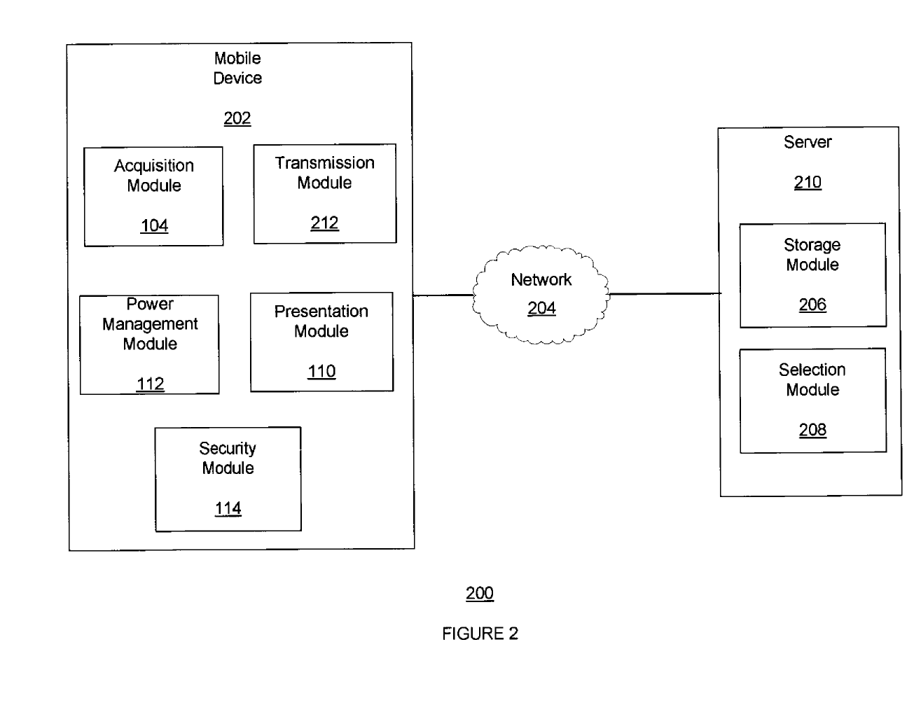

FIG. 2 is a schematic diagram of a system 200 for personalizing content for a mobile device 202 according to an embodiment of the present invention. FIG. 2 illustrates embodiments of a system and method for personalizing content for a mobile device 202 over a network. The mobile device 202 may include an acquisition module 204, a transmission module 212, a power management module 112, a presentation module 110, and a security module 114. The server 210 may include a storage module 206 and a selection module 208. In some embodiments, the storage module 206 and the selection module 208 may be housed on a server 210 remote from the mobile device 202. In some embodiments, the power management module 112 and the security module 114 may be housed on a server 210 remote from the mobile device 202. The modules of FIG. 2 may function the same or similar to the corresponding modules discussed in FIG. 1.

The server 210 may be remote from the mobile device 202. The server 210 may be any device capable of storing and/or processing data. The server 210 may be part of a network. In some embodiments, the server 210 may be part of a cloud computing network.

The mobile device 202 and the server 210 may communicate over a network 204. The network 204 may be a wireless network, a wired network or any combination of wireless network and wired network. For example, network 204 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11n, and 802.11g or any other wired or wireless network that permits communication between the mobile device 202 and the server 210. In addition, the network 204 may include, without limitation, telephone line, fiber optics, IEEE Ethernet 802.3, a Wide Area Network (“WAN”), a Local Area Network (“LAN”), or a global network such as the Internet.

The network 204 may further include one, or any number of the exemplary types of networks mentioned above operating as a stand-alone network or in cooperation with each other. The network 204 may utilize one or more protocols of one or more network elements to which it is communicatively coupled. The network 204 may translate to or from other protocols to one or more protocols of network devices. Although the network 204 is depicted as one network, it should be appreciated that according to one or more embodiments, network 204 may comprise a plurality of interconnected networks, such as, for example, a service provider network, the Internet, a publisher's network, an electronic content provider network, corporate networks, and home networks.

The acquisition module 104 may capture user identifiable content. The acquisition module 104 may communicate the user identifiable content to the transmission module 212. The transmission module 212 may communicate the user identifiable content to the server 210 over the network 204. The transmission module 212 may be any device capable of transmitting and receiving information. In some embodiments, the acquisition module 104 may transmit the user identifiable content directly to the server 210.

The server 210 may receive the user identifiable content. The server 210 may communicate the user identifiable content to the selection module 208. The selection module 208 may be remote from the mobile device 202. The selection module 208 may compare the user identifiable content to personalized content associated with one or more users of the mobile device 202. In some embodiments, the selection module 208 may compare an image of the current user of the mobile device 202 to numerous images stored in the storage module 206.

The selection module 208 may determine the current user of the mobile device 202. The selection module 208 may retrieve the personalized content directly associated with the current user of the mobile device 202. The selection module 208 may retrieve the personalized content from the storage module 206. In some embodiments, the selection module 208 may use cloud computing, software algorithms, and client-server software algorithms. The storage module 206 may store personalized content. The storage module 206 may store the personalized content on the server 210. The storage module 206 have an expansive library of data that expands across multiple computing networks.

FIG. 2 also illustrates embodiments of a system and method for personalizing content for a mobile device 202 where targeted materials may be provided to the current user of the mobile device 202. In some embodiments, any content available in both traditional and digital format may be used to generate object specific targeted content. The object specific targeted content may be an electronic download of any content available in both traditional and digital format. For example, an image of a CD jacket, DVD cover, a book, a magazine, and a newspaper may be used to generate object specific targeted content.

In some embodiments, the acquisition module 104 may capture one or more images of an object using the mobile device 202. The object may be a book, an advertisement, a product, a location, or anything thing else that may be captured.

The acquisition module 104 may communicate the one or more images to the transmission module 212. The transmission module 212 may transmit the one or more images to the server 210 over the network 204. In some embodiments, the acquisition module 104 may directly transmit the one or more images to the server 210 over the network 204. The server 210 may receive the one or more images and communicate the one or more images to the selection module 208. The selection module 208 may analyze the one or more images to identify information associated with the object. The selection module 208 may use computer-implemented software or computing algorithms to identify information associated with the object. The information associated with the object may be any characteristic or feature of the object. The selection module 208 may dissect the one or more images to identify information associated with the object. In some embodiments, the selection module 208 may analyze an image of a hardcopy book to identify certain information associated with the book. For example, the selection module 208 may analyze the book to identify the author and the title of the book. In another embodiment, the selection module 208 may analyze an image of an advertisement to identify certain information associated with the advertisement. For example, the selection module 208 may analyze the advertisement to determine the name and the type of product.

The selection module 208 may compare the information associated with the object to electronic content stored on the server 210. The selection module 208 may use algorithms or cloud computing to compare the information associated with the object to electronic content stored on the server 210. The electronic content may be any content that is stored electronically and available in electronic form. In some embodiments, the server 210 may be a part of a cloud computing network. In this embodiment, the electronic content may be any electronic content that is accessible over any network and/or the internet.

In some embodiments, the selection module 208 may compare a name, title, and author associated with a book to electronic content stored on the server 210. In this embodiment, the electronic content may be multiple books stored on the server 210 or accessible over any network including the internet.

The selection module 208 may identify identifying object specific targeted content directed to the object. Object specific targeted content may be information that is directly related to the object. Object specific targeted content may be content directly related to the user. Object specific targeted content may be any content. Object specific targeted content may be related or unrelated to the object or the user. Object specific targeted content may be targeted advertisements, a request, a command, downloadable content, an e-commerce transaction, a purchase transaction, a brochure, a product, and any other electronic content.

In some embodiments, the object related targeted content may relate to the personal preferences or personal tastes of the user. For example, based on the object or the information associated with the object, the selection module 208 may determine that individuals with similar personal taste as the user may also enjoy receiving information on other related products.

Object specific targeted content may be information related to the purchase of a product related or unrelated to the object. In some embodiments, if the image is of a magazine, the object specific targeted content may be information related to purchasing of an electronic version of the magazine or an electronic copy of the magazine. For example, the object specific targeted content may be the purchase price of the magazine. In some embodiments, the object specific targeted content may include a list of magazines that individuals with similar reacting taste may have purchased.

The server 210 may transmit the object specific targeted content to the mobile device 202 over the network 204. In some embodiments, the transmission module 212 may receive the object specific targeted content from the server 210. In some embodiments, prior to transmitting the object specific targeted content, a message may be transmitted to the mobile device 202. The message may be a confirmation message. The confirmation message may confirm that the current user of the mobile device 202 wants to receive the object specific targeted content. In some embodiments, the confirmation message may confirm that the current user of the mobile device 202 will proceed with a purchase transaction.

The transmission module 212 may communicate the object specific targeted content to the presentation module 110. The presentation module 110 may display or present the object specific targeted content on the mobile device 202. In some embodiments, the presentation module 110 may receive the object specific targeted content from the server 210.

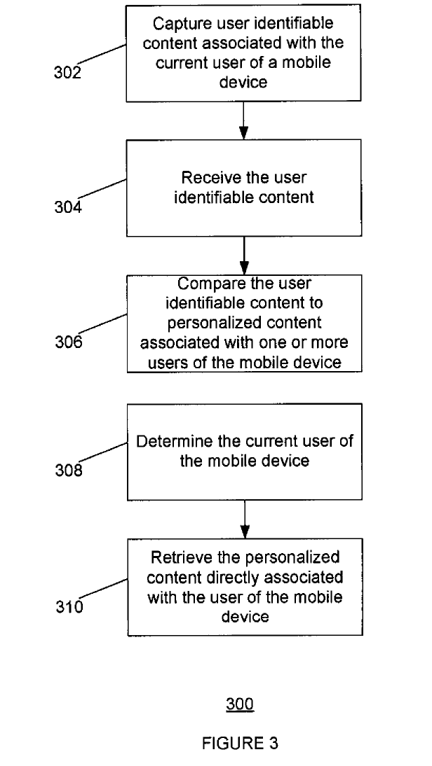

FIG. 3 illustrates a flowchart of a method for personalizing content for a mobile device according to an embodiment of the present invention. At block 302, user identifiable content associated with the current user of the mobile device 102 is captured. The acquisition module 104 may capture the user identifiable content. At block 304, the user identifiable content is received. The user identifiable content may be received by the selection module 108. In some embodiments, the storage module 106 may receive the user identifiable content.

At block 306, the user identifiable content is compared to personalized content associated with one or more users of the mobile device 102. The selection module 108 may compare the user identifiable content to the personalized content associated with the one or more users of the mobile device 102. At block 308, the current user of the mobile device 102 is determined. The selection module 108 may determine the current user of the mobile device 102. The selection module 108 may determine the current user of the mobile device 102 based on comparing the user identifiable content to the personalized content. At block 310, the personalized content directly associated with the current user of the mobile device 102 is retrieved. The selection module 108 may retrieve the personalized content. The selection module 108 may retrieve the personalized content from the storage module 106.

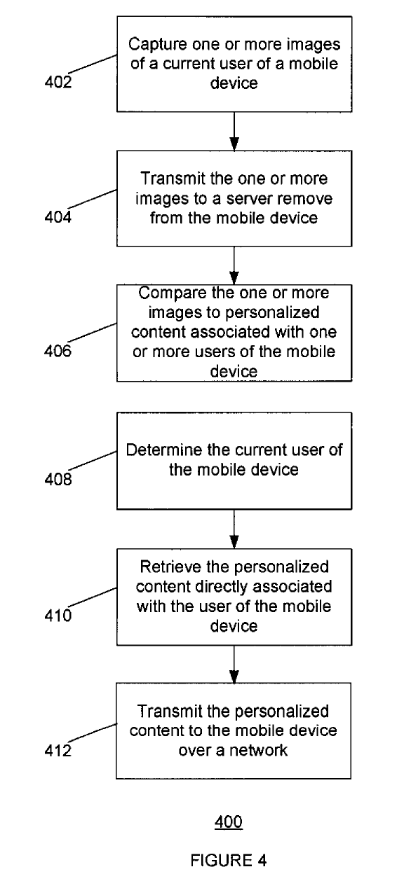

FIG. 4 illustrates a flowchart of a method for personalizing content for a mobile device according to an embodiment of the present invention. At block 402, one or more images of a current user of the mobile device 202 are captured. The acquisition module 104 may capture the one or more images of the current user of the mobile device 202. At block 404, the one or more images may be transmitted to a server 210 remote from the mobile device 202. The transmission module 212 may transmit the one or more images to the server 210. The transmission module 212 may transmit the one or more images over a network 204. In some embodiments, the acquisition module 104 may transmit the one or more images directly to the server 210.

At block 406, the one or more images may be compared to personalized content associated with one or more users of the mobile device 202. The selection module 208 may compare the one or more images to the personalized content. The selection module 208 may communicate with the storage module 206 in order to compare the one or more images with the personalized content. At block 408, the current user of the mobile device 202 is determined. The selection module 208 may determine the current user of the mobile device 202. The selection module 208 may use cloud computing and/or computer-implemented software algorithms to determine the current user of the mobile device 202. At block 410, personalized content directly associated with the current user of the mobile device 202 is retrieved. The selection module 208 may retrieve the personalized content directly associated with the current user of the mobile device 202. The selection module 208 may retrieve the personalized content from the storage module 206. At block 412, personalized content may be transmitted to the mobile device 202 over a network 204. The server 210 may transmit the personalized content to the mobile device 202. In some embodiments, the server 210 may transmit the personalized content directly to the presentation module 110.

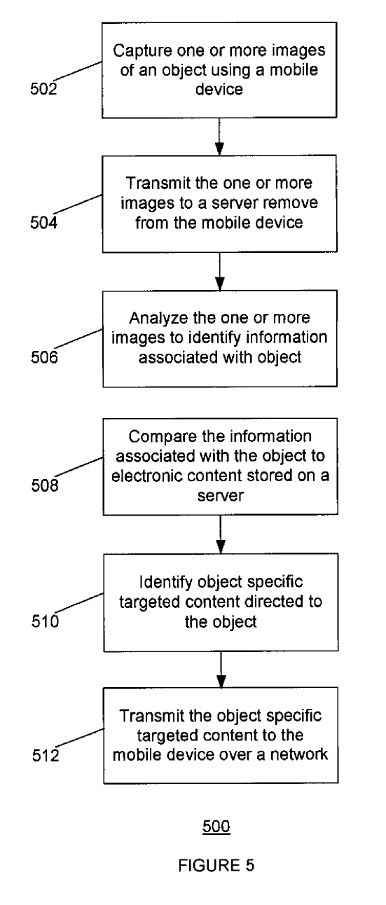

FIG. 5 illustrates a flowchart of a method for personalizing content for a mobile device according to an embodiment of the present invention. At block 502, one or more images of an object are captured using the mobile device 202. The acquisition module 104 may capture the one or more images of an object. At block 504, the one or more images are transmitted to a server 210 remote from the mobile device. The transmission module 212 may transmit the one or more images to the server 210. The transmission module 212 may transmit the one or more images over a network 204. In some embodiments, the acquisition module 104 may transmit the one or more images directly to the server 210. At block 506, the one or more images are analyzed to identify information associated with the object. The selection module 208 may analyze the one or more images. The selection module 208 may dissect the one or more images.

At block 508, the information associated with the object is compared to electronic content stored on the server 210. The selection module 208 may compare the information associated with the object to electronic content stored on the server 210. For example, the selection module 208 may compare a company logo in an advertisement to multiple images of company logos and related products stored on the server 210.

At block 510, object specific targeted content directed to the object is identified. The selection module 208 may identify the object specific targeted content directed to the object. The may selection module 208 may communicate with the storage module 206 to identify the object specific targeted content. At block 512, the object specific targeted content is transmitted to the mobile device 202 over a network 204. The server 210 may transmit the object specific targeted content to the mobile device 202. In some embodiments, the server 210 may transmit the object specific targeted content directly to the presentation module 110.

The description above describes systems, networks, and reader devices, that may include one or more modules, some of which are explicitly shown in the figures. As used herein, the term “module” may be understood to refer to any, or a combination, of computer-implemented software, firmware, and hardware. It is noted that the modules are exemplary. The modules may be combined, integrated, separated, or duplicated to support various applications. Also, a function described herein as being performed at a particular module may be performed at one or more other modules or by one or more other devices instead of or in addition to the function performed at the particular module. Further, the modules may be implemented across multiple devices or other components local or remote to one another. Additionally, the modules may be moved from one device and added to another device, or may be included in multiple devices.

It is further noted that the software described herein may be tangibly embodied in one or more physical media, such as, but not limited to any, or a combination, of a compact disc (CD), a digital versatile disc (DVD), a floppy disk, a hard drive, read only memory (ROM), random access memory (RAM), and other physical media capable of storing software. Moreover, the figures illustrate various components (e.g., systems, networks, and reader devices) separately. The functions described as being performed at various components may be performed at other components, and the various components may be combined or separated. Other modifications also may be made.

In the instant specification, various exemplary embodiments have been described with reference to the accompanying drawings. It will, however, be evident that various modifications or changes may be made thereto, or additional embodiments may be implemented, without departing from the broader scope of the invention as set forth in the claims that follow. The specification and drawings are accordingly to be regarded in an illustrative rather than a restrictive sense.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

While the foregoing illustrates and describes exemplary embodiments of this invention, it is to be understood that the invention is not limited to the construction disclosed herein. The invention can be embodied in other specific forms without departing from its spirit or essential attributes.

We claim:

1. A system for personalizing content for a mobile device, comprising:
an acquisition module configured to capture user identifiable content associated with the current user of the mobile device, the acquisition module being coupled to the mobile device;
a storage module configured to store personalized content associated with one or more users of the mobile device; and
a selection module configured to:
receive the user identifiable content,
compare the user identifiable content to the personalized content,
determine the current user of the mobile device based on the user identifiable content, and
retrieve the personalized content directly associated with the current user of the mobile device.

2. The system of claim 1, further comprising a presentation module configured to present the personalized content on the mobile device.

3. The system of claim 2, wherein the mobile device is an electronic reader device.

4. The system of claim 3, wherein the acquisition module is an image acquisition device, a camera, video recording device, an audio recording device or a voice recognition device.

5. The system of claim 4, wherein the user identifiable content is one or more images of the current user of the mobile device.

6. The system of claim 3, wherein the personalized content comprises personal information, electronic books, software applications, personal preferences and personal documents.

7. The system of claim 3, wherein the storage module and the selection module are located on a server remote from the mobile device.

8. The system of claim 7, further comprising a transmission module configured to:
transmit the user identifiable content associated with the current user to the server; and
receive the personalized content associated with the current user of the mobile device from the server.

9. The system of claim 1, further comprising a security module configured to:
determine whether the current user of the mobile device is an authorized user based on the user identifiable content; and
provide the current user of the mobile device access to the mobile device if the current user is an authorized user.

10. The system of claim 1, further comprising a power management module configured to adjust the power settings of the mobile device based on the user identifiable content.

11. The system of claim 1, wherein the selection module uses video recognition, software algorithms or cloud computing to compare, determine and retrieve.

12. The system of claim 1, wherein the user identifiable content is one or more voice recordings of the current user of the mobile device.

13. A method for personalizing content for a mobile device, the method comprising:
capturing user identifiable content associated with the current user of the mobile device:
receiving the user identifiable content;
comparing the user identifiable content to personalized content associated with one or more users of the mobile device;
determining the current user of the mobile device; and
retrieving the personalized content directly associated with the current user of the mobile device.

14. The method of claim 13, wherein the mobile device is an electronic reader device.

15. The method of claim 13, further comprising
presenting the personalized content on the mobile device.

16. The method of claim 13, wherein the user identifiable content is one or more images of the current user of the mobile device.

17. The method of claim 13, further comprising:
transmitting the user identifiable content associated with the current user to a server; and
receiving the personalized content associated with the current user of the mobile device from the server.

18. A method for personalizing content for a mobile device, the method comprising:
capturing one or more images of a current user of the mobile device;
transmitting the one or more images to a server remote from the mobile device;
comparing the one or more images to personalized content associated with one or more users of the mobile device;
determining the current user of the mobile device;
retrieving the personalized content directly associated with the current user of the mobile device, and
transmitting the personalized content to the mobile device over a communications network.

19. The method of claim 18, wherein the mobile device is an electronic reader device.

20. The method of claim 18, wherein the one or more images are captured periodically at certain intervals.

21. The method of claim 18, further comprising:
presenting the personalized content on the mobile device.

22. The method of claim 18, further comprising:
adjusting the power settings of the mobile device based the user identifiable content.

23. A method for personalizing content for a mobile device, the method comprising:
capturing one or more images of an object using the mobile device;
transmitting the one or more images to a server remote from the mobile device;
analyzing the one or more images to identify information associated with the object;
comparing the information associated with the object to electronic content stored on the server;
identifying object specific targeted content directed to the object;
transmitting the object specific targeted content to the mobile device over a network.

24. The method of claim 23, wherein, prior to transmitting the object specific targeted content, a confirmation message is transmitted to the mobile device to confirm that a current user of mobile device wants to receive the object specific targeted content.

25. The method of claim 23, wherein the object is a book.

26. The method of claim 25, wherein the object specific targeted content is information related to the purchase of an electronic version of the book.

27. The method of claim 25, wherein the object specific targeted content is an electronic copy of the book.
